(19) United States
(12) Patent Application Publication
(10) Pub. No.: US 2020/0131728 A1
(43) Pub. Date: Apr. 30, 2020

(54) Snow Melting Assembly

(71) Applicant: Deon Allen, Greenwood, IN (US)

(72) Inventor: Deon Allen, Greenwood, IN (US)

(21) Appl. No.: 16/168,961

(22) Filed: Oct. 24, 2018

(51) Int. Cl. E01H 5/10; E01C 11/26; H05B 3/36

(52) U.S. Cl. CPC E01H 5/10; E01C 11/265; H05B 2214/02; H05B 2203/035; H05B 3/36

(57) ABSTRACT

A snow melting assembly for a driveway includes a controller that comprises a microprocessor and a receiver. The receiver is operationally coupled to the microprocessor. A cable is coupled to and extends from the controller. A first mat is coupled to the cable distal from the controller. The first mat comprises rubber so that the first mat is resiliently compressible and rollable. A first heating element is embedded in the first mat. The first heating element is operationally coupled to the cable. A power cord is coupled to and extends from the controller. The power cord is configured to couple the controller to a source of electrical current. Programming code is positioned on an electronic device that enables a user to wirelessly communicate with the microprocessor, via the receiver, to signal the microprocessor to actuate the first heating element to melt the snow that is positioned on the first mat.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relate to melting assemblies and more particularly pertains to a new melting assembly for a driveway.

### BRIEF SUMMARY OF THE INVENTION

An embodiment of the disclosure meets the needs presented above by generally comprising a controller that comprises a microprocessor and a receiver. The receiver is operationally coupled to the microprocessor. A cable is coupled to and extends from the controller. A first mat is coupled to the cable distal from the controller. The first mat comprises rubber so that the first mat is resiliently compressible and rollable. A first heating element is embedded in the first mat. The first heating element is operationally coupled to the cable. A power cord is coupled to and extends from the controller. The power cord is configured to couple the controller to a source of electrical current. Programming code is positioned on an electronic device that enables a user to wirelessly communicate with the microprocessor, via the receiver, to signal the microprocessor to actuate the first heating element to melt the snow that is positioned on the first mat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a snow melting assembly according to an embodiment of the disclosure.

FIG. 2 is an in-use view of an embodiment of the disclosure.

FIG. 3 is a cross-sectional view of an embodiment of the disclosure.

FIG. 4 is a block diagram of an embodiment of the disclosure.

### DETAILED DESCRIPTION OF THE INVENTION

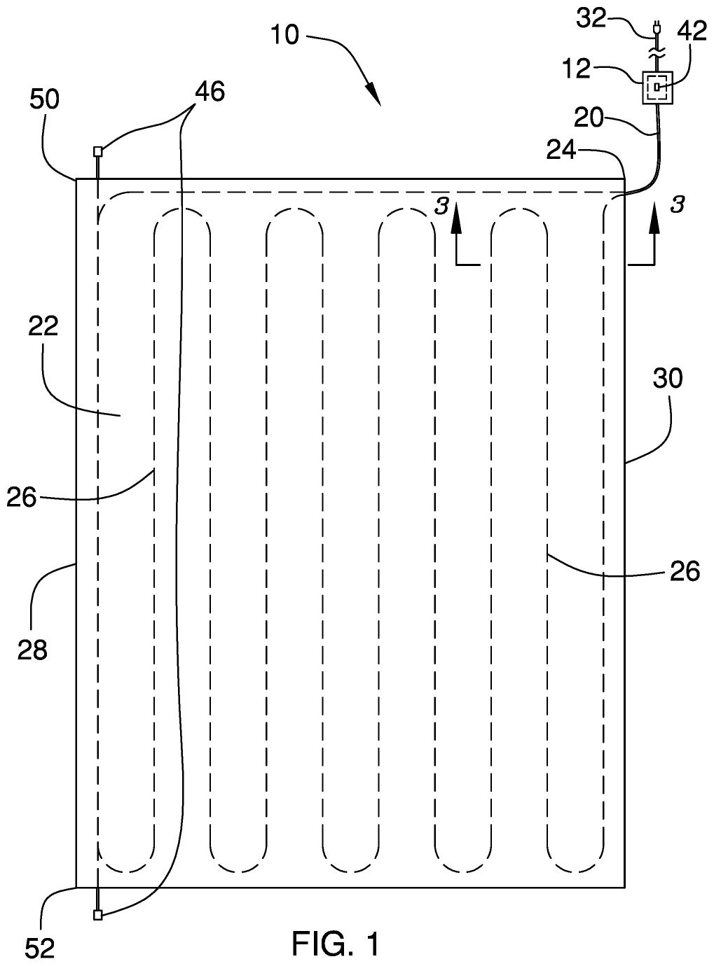

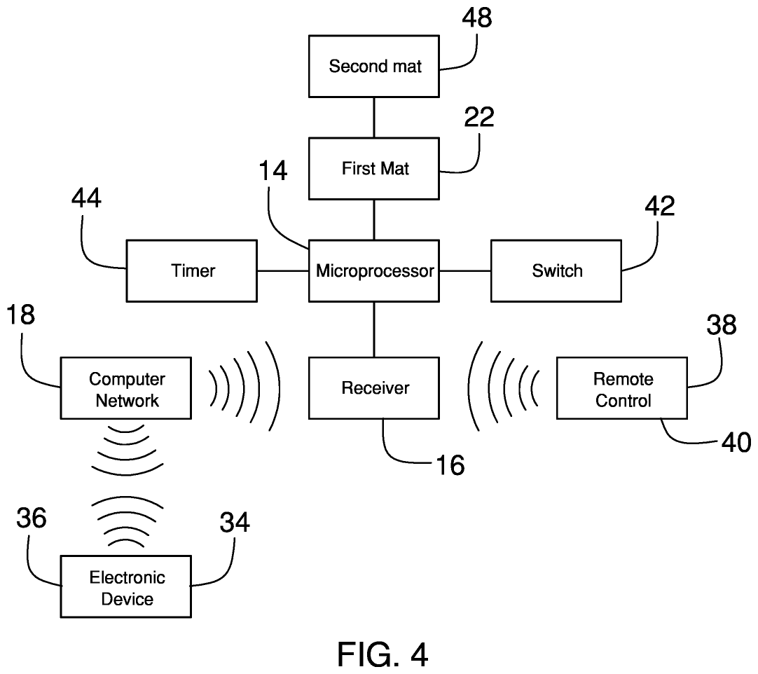

With reference now to the drawings, and in particular to FIGS. 1 through 4 thereof, a new melting assembly embodying the principles and concepts of an embodiment of the disclosure and generally designated by the reference numeral 10 will be described.

As best illustrated in FIGS. 1 through 4, the snow melting assembly 10 generally comprises a controller 12, which in turn comprises a microprocessor 14 and a receiver 16. The receiver 16 is operationally coupled to the microprocessor 14. The receiver 16 allows the controller 12 to be wirelessly coupled to a computer network 18, such as a home network. A cable 20 is coupled to and extends from the controller 12.

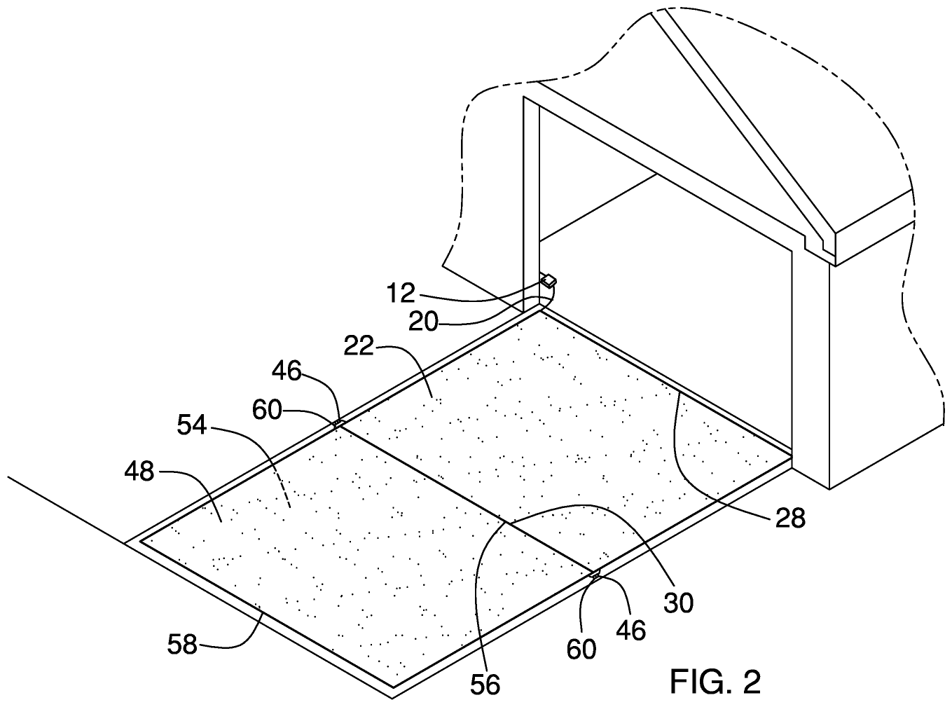

A first mat 22, which is rectangularly shaped, is coupled to the cable 20 distal from the controller 12. The cable 20 extends from proximate to a first corner 24 of the first mat 22. The first mat 22 comprises rubber so that the first mat 22 is resiliently compressible and rollable. The first mat 22 is constructed of rubber so that is can be rolled up and stored when not in use. When required, the first mat 22 can be positioned on a driveway proximate to a garage door opening, and then unrolled to cover the driveway, as shown in FIG. 2, with the controller 12 positioned in the interior of the garage to protect it from the elements and to be readily accessible to a user.

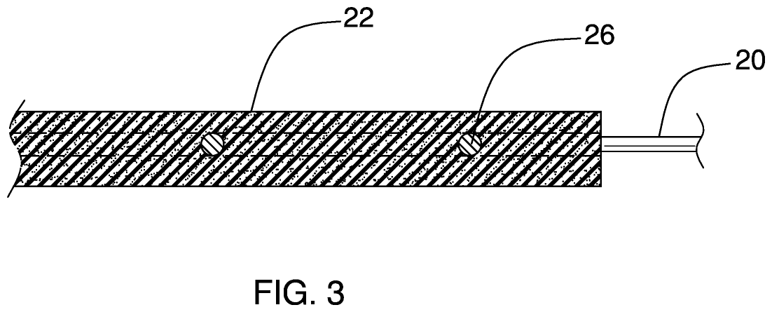

A first heating element 26 is embedded in the first mat 22, as shown in FIG. 3. The first heating element 26 is operationally coupled to the cable 20. The first heating element 26 extends loopedly between a first end 28 and a second end 30 of the first mat 22, as shown in FIG. 1. The composition of the first mat 22 enables driving of a vehicle over the first mat 22 without damaging the first mat 22 or the first heating element 26. A power cord 32 is coupled to and extends from the controller 12. The power cord 32 is configured to couple the controller 12 to a source of electrical current.

Programming code 34 is positioned on an electronic device 36, such as a home computer, a laptop computer, a smartphone, or the like. The programming code 34 enables the user to wirelessly communicate with the microprocessor 14, via the receiver 16, to signal the microprocessor 14 to actuate the first heating element 26 to melt the snow that is positioned on the first mat 22.

The assembly 10 also comprises a remote control 38, which in turn comprises a transmitter 40. The user is positioned to selectively actuate the remote control 38 to wirelessly communicate with the microprocessor 14, via the receiver 16, to signal the microprocessor 14 to actuate the first heating element 26 to melt the snow that is positioned on the first mat 22. The transmitter 40 may signal the controller 12 via the computer network 18 or directly via radio signaling.

A switch 42 is coupled to the controller 12 and is operationally coupled to the microprocessor 14. The switch 42 is configured to be selectively switched to signal the microprocessor 14 to actuate the first heating element 26 to melt the snow that is positioned on the first mat 22. The switch 42 provides manual control to the user when the user is proximate to the controller 12.

A timer 44 is operationally coupled to the microprocessor 14. The timer 44 is positioned to signal the microprocessor 14 to deactivate the first heating element 26 upon elapsing of a preset time. The timer 44 allows the user to program the preset time so that the first heating element 26 heats the first mat 22 for a desired period.

The assembly 10 also comprises pair of first connectors 46 and a second mat 48, as shown in FIG. 2. The first connectors 46 are coupled singly to and extend from the first mat 22 proximate to a second corner 50 and a third corner 52 of the first mat 22. Like the first mat 22, the second mat 48 comprises rubber so that the second mat 48 is resiliently compressible and rollable.

A second heating element 54 embedded in the second mat 48. The second heating element 54 extends loopedly from a first edge 56 of the second mat 48 to a second edge 58 of the second mat 48.

A pair of second connectors 60 is coupled to and extends from the second mat 48. The second connectors 60 are operationally coupled to the second heating element 54. The second connectors 60 are complementary to the first connectors 46 so that each second connector 60 is positioned to selectively couple to a respective first connector 46. The second heating element 54 is operationally coupled to the controller 12 through the first heating element 26 and is actuated concurrently with the first heating element 26 to melt snow that is positioned on the second mat 48. The second mat 48 allows the assembly 10 to be used with a longer driveway. The present invention anticipates that multiple second mats 48 could be sequentially coupled to the first mat 22 to cover even longer driveways.

In use, the first mat 22 is positioned on the driveway proximate to the garage door opening, and then unrolled to cover the driveway. When required, the user can activate the first heating element 26, via the switch 42, the remote control 38, or the electronic device 36, to melt the snow that is positioned on the first mat 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A snow melting assembly comprising:
a controller comprising a microprocessor and a receiver, the receiver being operationally coupled to the microprocessor;
a cable coupled to and extending from the controller;
a first mat coupled to the cable distal from the controller, the first mat comprising rubber such that the first mat is resiliently compressible and rollable;
a first heating element embedded in the first mat, the first heating element being operationally coupled to the cable;
a power cord coupled to and extending from the controller wherein the power cord is configured for coupling the controller to a source of electrical current; and
programming code positioned on an electronic device of a user wherein the user is enabled for wirelessly communicating with the microprocessor via the receiver for signaling the microprocessor for actuating the first heating element for melting snow positioned on the first mat.

2. The assembly of claim 1, further including the first mat being rectangularly shaped.

3. The assembly of claim 2, further including the cable extending from proximate to a first corner of the first mat.

4. The assembly of claim 1, further including the first heating element extending loopedly between a first end and a second end of the first mat.

5. The assembly of claim 1, further including a remote control comprising a transmitter wherein the user is positioned for selectively actuating the remote control for wirelessly communicating with the microprocessor via the receiver for signaling the microprocessor for actuating the first heating element for melting the snow positioned on the first mat.

6. The assembly of claim 1, further including a switch coupled to the controller, the switch being operationally coupled to the microprocessor wherein the switch is configured for selectively switching for signaling the microprocessor for actuating the first heating element for melting the snow positioned on the first mat.

7. The assembly of claim 1, further including a timer, the timer being operationally coupled to the microprocessor wherein the timer is positioned for signaling the microprocessor for deactivating the first heating element upon elapsing of a preset time.

8. The assembly of claim 3, further comprising:
a pair of first connectors, the first connectors being coupled singly to and extending from the first mat proximate to a second corner and a third corner of the first mat;
a second mat, the second mat comprising rubber such that the second mat is resiliently compressible and rollable;
a second heating element embedded in the second mat; and
a pair of second connectors coupled to and extending from the second mat, the second connectors being operationally coupled to the second heating element, the second connectors being complementary to the first connectors wherein each second connector is positioned for selectively coupling to a respective first connector such that the second heating element is operationally coupled to the controller through the first heating element wherein the second heating element is actuated concurrently with the first heating element for melting snow positioned on the second mat.

9. The assembly of claim 8, further including the second heating element extending loopedly from a first edge of the second mat to a second edge of the second mat.

10. A snow melting assembly comprising:
a controller comprising a microprocessor and a receiver, the receiver being operationally coupled to the microprocessor;
a cable coupled to and extending from the controller;
a first mat coupled to the cable distal from the controller, the first mat comprising rubber such that the first mat is resiliently compressible and rollable, the first mat being rectangularly shaped, the cable extending from proximate to a first corner of the first mat;
a first heating element embedded in the first mat, the first heating element being operationally coupled to the cable, the first heating element extending loopedly between a first end and a second end of the first mat;
a power cord coupled to and extending from the controller wherein the power cord is configured for coupling the controller to a source of electrical current;
programming code positioned on an electronic device of a user wherein the user is enabled for wirelessly communicating with the microprocessor via the receiver for signaling the microprocessor for actuating the first heating element for melting snow positioned on the first mat;
a remote control comprising a transmitter wherein the user is positioned for selectively actuating the remote control for wirelessly communicating with the microprocessor via the receiver for signaling the microprocessor for actuating the first heating element for melting the snow positioned on the first mat;
a switch coupled to the controller, the switch being operationally coupled to the microprocessor wherein the switch is configured for selectively switching for signaling the microprocessor for actuating the first heating element for melting the snow positioned on the first mat;
a timer, the timer being operationally coupled to the microprocessor wherein the timer is positioned for signaling the microprocessor for deactivating the first heating element upon elapsing of a preset time;
a pair of first connectors, the first connectors being coupled singly to and extending from the first mat proximate to a second corner and a third corner of the first mat;
a second mat, the second mat comprising rubber such that the second mat is resiliently compressible and rollable;
a second heating element embedded in the second mat, the second heating element extending loopedly from a first edge of the second mat to a second edge of the second mat; and
a pair of second connectors coupled to and extending from the second mat, the second connectors being operationally coupled to the second heating element, the second connectors being complementary to the first connectors wherein each second connector is positioned for selectively coupling to a respective first connector such that the second heating element is operationally coupled to the controller through the first heating element wherein the second heating element is actuated concurrently with the first heating element for melting snow positioned on the second mat.
